(19) United States
(12) Patent Application Publication
(10) Pub. No.: US 2020/0265452 A1
(43) Pub. Date: Aug. 20, 2020

(54) COMPUTER-IMPLEMENTED REFERRAL NETWORK AND SYSTEM AND METHOD FOR REWARDING USERS PROVIDING REFERRALS

(71) Applicant: Ellen Lippman, Las Vegas, NV (US)

(72) Inventor: Ellen Lippman, Las Vegas, NV (US)

(21) Appl. No.: 16/281,027

(22) Filed: Feb. 20, 2019

(51) Int. Cl. G06Q 30/02

(52) U.S. Cl. CPC G06Q 30/0214; G06Q 30/0281

(57) ABSTRACT

A system and method utilizing a processor running executable instructions to maintain a referral network through which participants may refer business or potential clients. One primary feature is a ranking protocol based on referrals given. The ranking feature increases the likelihood that those giving referrals will receive referrals as well. As detailed herein, the system and method are quid pro quo in nature thereby rewarding those who assist others. In this manner, the system and method utilize reciprocity to encourage all participants to refer—not simply seek referrals. The system and method may be implemented via a computer network accessed via mobile devices. Referrals may be made and received via Apps or dedicated websites. Such a computer network provides nearly real time responsiveness benefiting both the client and the service provider.

### FIELD OF THE INVENTION

The embodiments of the present invention relate to a system and method for developing a referral network and rewarding those providing referrals.

### BACKGROUND

Referrals are important in the service industry. The legal and real estate industries are just two industries predicated on referrals. Referrals can generate revenue for the referees, but not always for the referrer. That is, although a first service provider may refer a potential client to a second service provider, there is no assurance the second service provider will reciprocate and send the first service provider a referral in the future. Moreover, some industries, including the legal industry, regulate that ability to pay referral fees.

It would thus be advantageous to develop a system and method that ensure, or at least improves the chances, that a referrer of potential clients will also be the recipient of future referrals. Moreover, the system and method should be facilitated by computer means and distributed via the Internet or mobile software applications (“Apps”) accessible via mobile devices (e.g., smart phones).

### SUMMARY

The embodiments of the present invention utilize a processor running executable instructions to maintain a referral network through which participants may refer business or potential clients. One primary feature is a ranking protocol based on referrals given. The ranking feature increases the likelihood that those giving referrals will receive referrals as well. As detailed herein, the system and method are quid pro quo in nature thereby rewarding those who assist others. In this manner, the system and method utilize reciprocity to encourage all participants to refer—not simply seek referrals.

The embodiments of the present invention may be implemented via a computer network accessed via mobile devices. Referrals may be made and received via Apps or dedicated websites. Such a computer network provides nearly real time responsiveness benefiting both the client and the service provider.

Other variations, embodiments and features of the present invention will become evident from the following detailed description, drawings and claims.

### BRIEF DESCRIPTION OF THE DRAWINGS

FIG. 1 illustrates a block diagram of a wireless mobile device network which may be used to facilitate the embodiments of the present invention;

FIG. 2 illustrates a block diagram of storage facility of the system according to the embodiments of the present invention;

FIGS. 3A through 3D illustrate exemplary webpages depicting implementation of a referral network according to the embodiments of the present invention;

FIGS. 4A through 4D illustrate exemplary mobile device push notices transmitted to an agent referring a client and/or business and an agent receiving the referral according to the embodiments of the present invention;

FIG. 5 illustrates a flow chart detailing one method of implementing the referral network according to the embodiments of the present invention; and

FIG. 6 illustrates a diagram showing a referral network according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the virtual, digital and online embodiments of the present invention involve both hardware and software elements which portions are described below in such detail required to construct and operate a game method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object-oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices (e.g., smart phone, smart tablet, etc.) to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams.

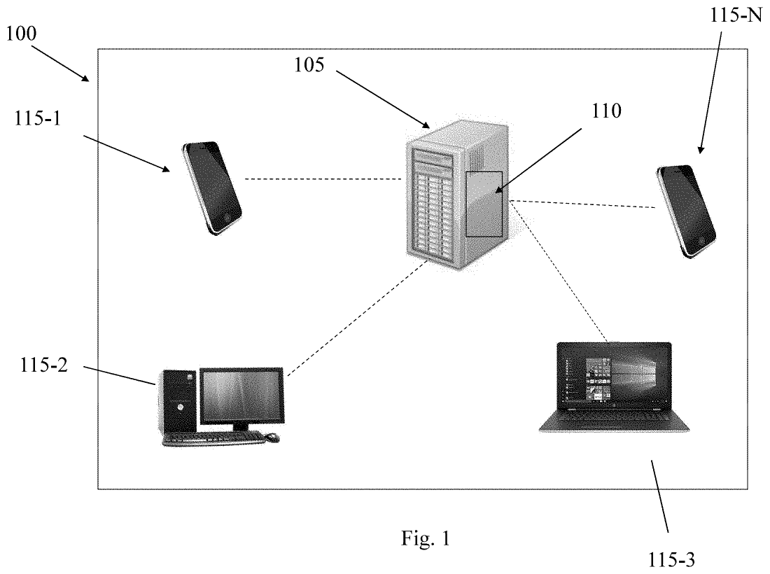

FIG. 1 shows a block diagram of a system/network 100 which may be used to facilitate the embodiments of the present invention. With this embodiment, an App may be downloaded onto smart phones or tablets and/or users may access a dedicated website (e.g., www.therefolution.com) using a conventional web browser. The network 100 comprises a server 105, including one or more processors 110 running system software, and remote devices 115-1 through 115-N configured to access said server 110 and said dedicated website or Apps (these may also be stored in the mobile device). Using the remote devices 115-1 through 115-N (e.g., mobile smart devices), users may refer and be referred potential clients.

The system and method detailed herein are ideal for real estate but those skilled in the art are also suitable for other industries such as legal and other service providers. For purposes of brevity, the detailed description below focuses on the real estate industry as the exemplary industry.

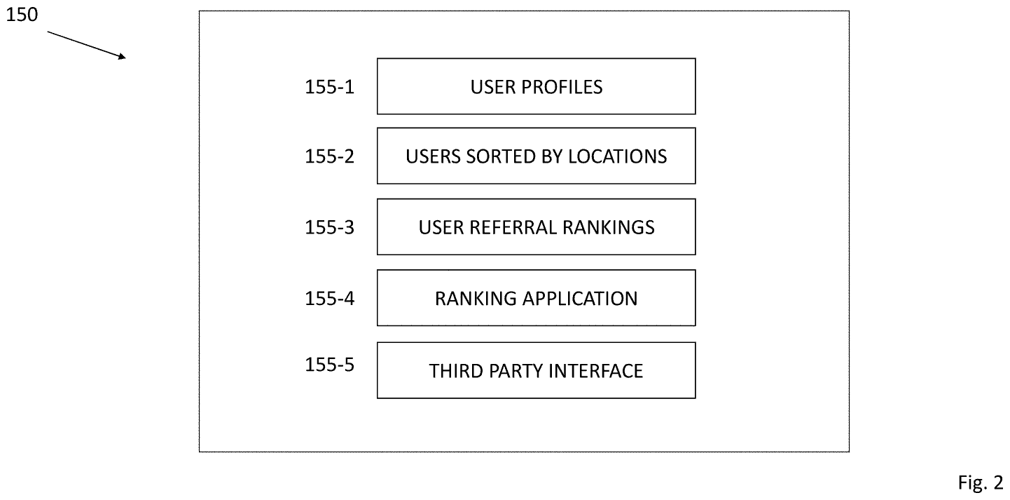

FIG. 2 shows a block diagram of a storage facility 150 of the system 100. The backend 150 comprises a plurality of databases 155-1 through 155-7, including a user profiles database 155-1, users sorted by location database 155-2, user referral rankings database 155-3, ranking application database 155-4, third-party interface database 155-5, application process database 155-6 and advertisement/content database 155-7. Each of the databases 155-1 through 155-7 is detailed below. Additional databases may be incorporated into the system 100 or a single partitioned database may maintain and manage data.

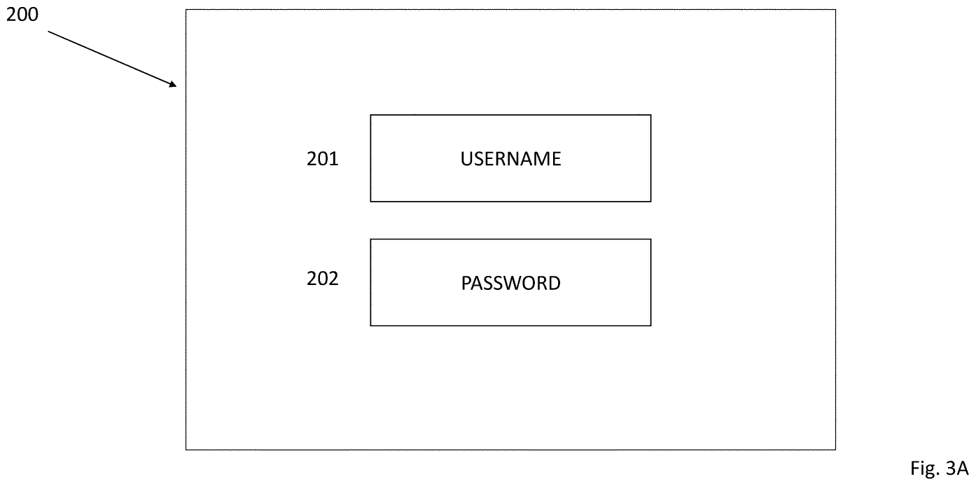

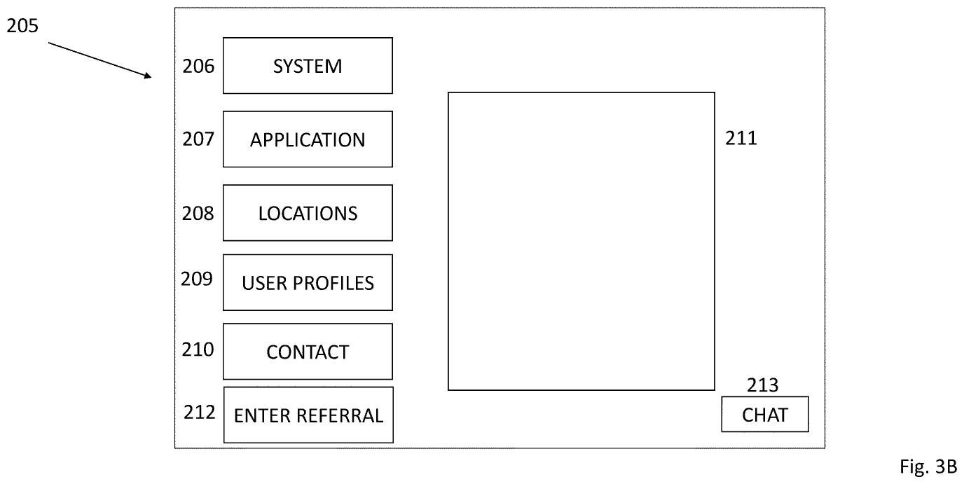

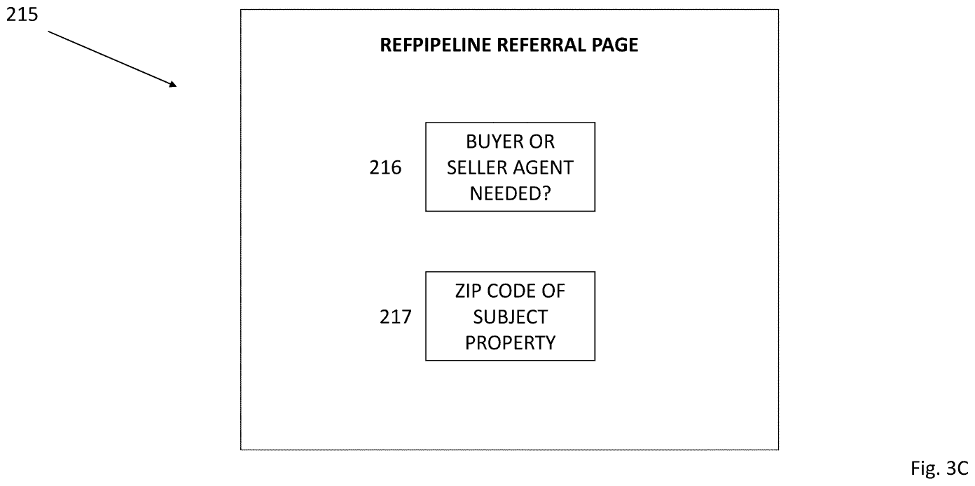

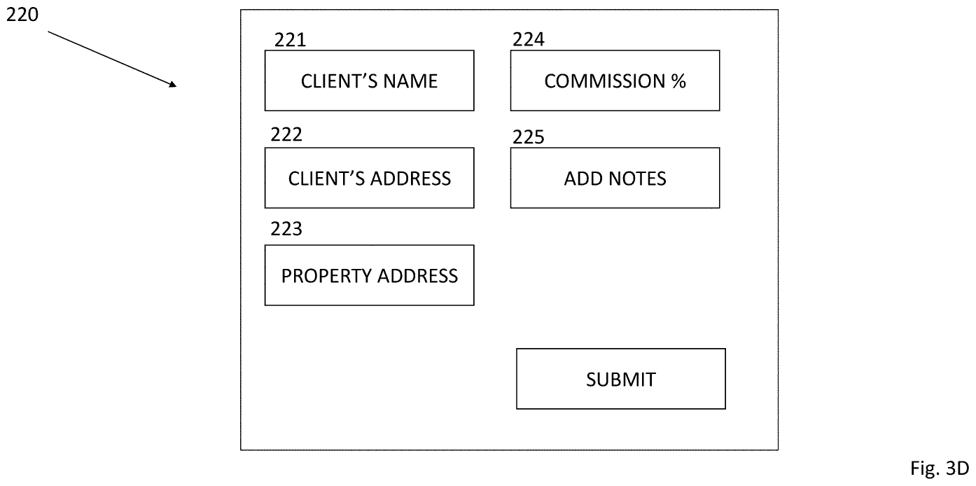

FIGS. 3A through 3C show exemplary webpages depicting implementation of a referral network according to the embodiments of the present invention. FIG. 3A shows a login page 200 through which registered users may access a dedicated website or subject App by inputting a username 201 and password 202. The registration process comprises each potential user submitting an application for participation in the referral network. Upon completion of the application, the system 100 verifies personal information including active licensure of the potential user. That is, the system verifies that real estate agents, brokers, mortgage brokers, etc., have active licenses. Such information may be obtained by the system 100 being in communication with certain state agencies being privy to such information. In one embodiment, the third-party interface database 155-5 is configured to maintain substantially real-time, bi-directional communications between the system 100 and third-party information providers (e.g., escrow companies). Background checks and other due diligence regarding each potential user may be conducted prior to the potential user being approved.

Once a registered user provides the username and password, a home page 205 appears, as shown in FIG. 3B. The home page 205 provides users with information on various topics, including the system and how it works 206, the application process and application form 207 (maintained by the application process database 155-6), locations of active service providers 208 (maintained by the users sorted by location database 155-2), profiles of active service providers 209 (maintained by the user profiles database 155-1), contact information 210, advertisements/content 211 (maintained by advertisement/content database 155-6) and the like. A referral icon 212 allows users to enter a referral into the system 100. The home page 205 may also have a chat feature 213 configured to allow registered users to communicate with one another.

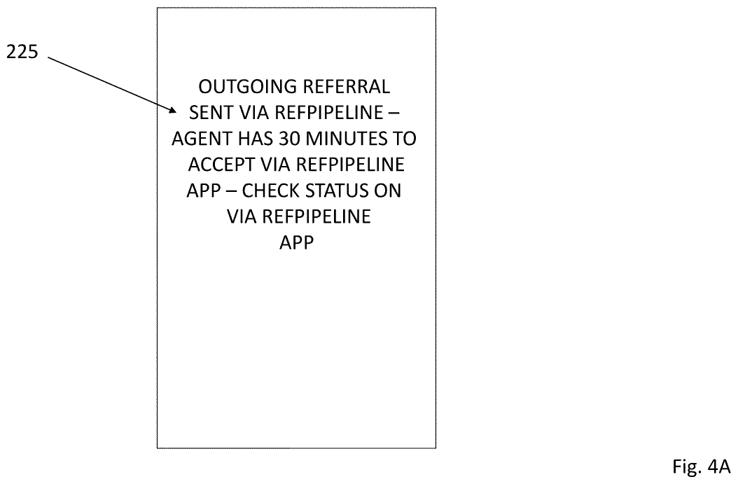

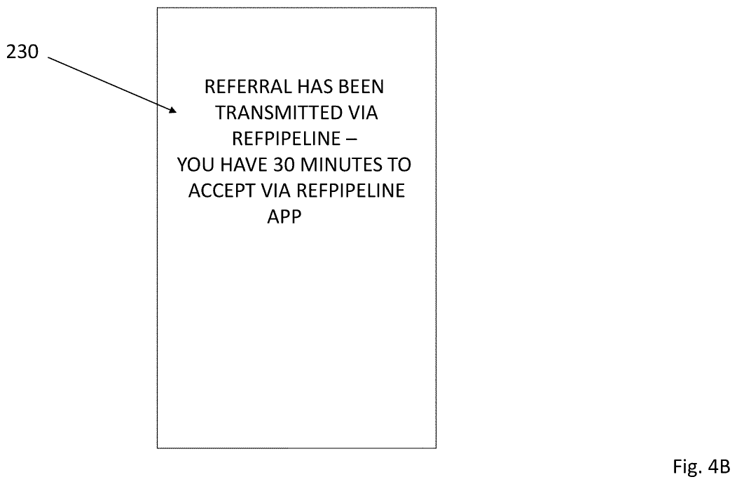

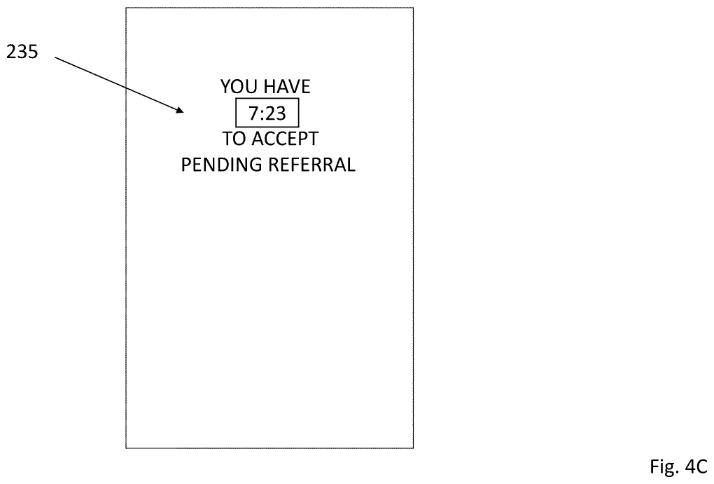

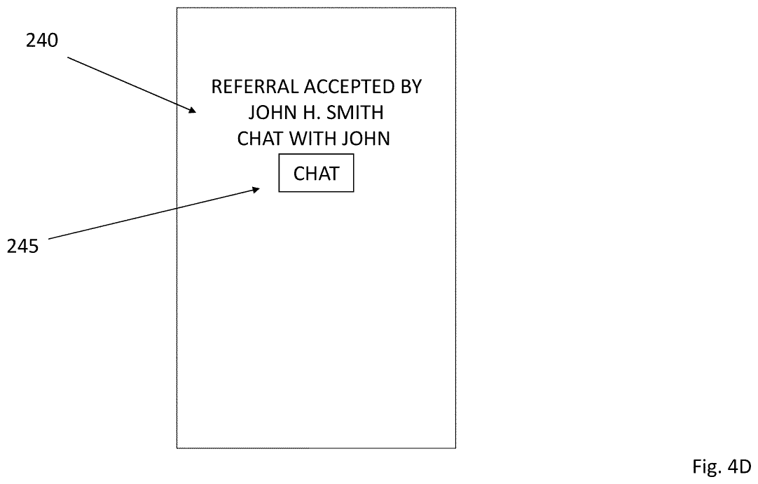

Now referring to FIG. 3C, responsive to a user selecting the referral icon 212, a webpage 215 appears through which the user may enter a referral opportunity. This may also be accomplished through a smart device when accessing the dedicated website or via an App downloaded thereon. Webpage 215 serves as a data entry portal. The webpage 215 includes an agent selection icon 216 and property zip code icon 217. Once the user selects the agent needed and the property location, a data entry webpage 220 is presented. The data entry webpage 220 serves to collect information, including the client's name 221, client's address 222, property address if one exists 223, commission % if established 224 and a section for notes 225 for the referring agent to pass along additional relevant information regarding the referral. In one embodiment, a push notice 225, as shown in FIG. 4A, is transmitted to an agent meeting the referral requirements, namely a seller's or buyer's agent licensed and knowledgeable regarding the area defined by, or proximate to, the zip code. The system 100 selects the agent to receive the push notice 225 using the ranking application maintained by the ranking agent database 155-4. FIG. 4B shows a push notice 230 transmitted to the agent responsible for the referral. FIG. 4C shows an exemplary timer 235 associated with the acceptance of the referral.

The referral to the agent selected by the system 100 is limited in duration. In one embodiment, the agent receiving the referral has 30 minutes to accept the same. Should the selected agent not accept the referral within the allotted time period, the system 100 selects the next eligible agent to receive the referral. If the agent accepts the referral within the allotted time period, as shown in FIG. 4D, a push notice 240 is transmitted to the agent responsible for the referral confirming the acceptance and the name of the accepting agent. A CHAT icon 245 permits the referring agent to communicate with the accepting agent. The system 100 may also transmit a CHAT icon to the accepting agent responsive to the agent accepting the referral. Once a referral is accepted, the referring agent may access the App or website to track the status of the client or business referred. The status may be updated by referred agent inputs into the system 100 or direct communications between the system 100 and escrow companies and the like handling the underlying referred transaction.

In a simplest form, the ranking application places agents in a queue based on the time when they make the referral. So, if there are two agents already in the queue for a geographic location when an agent gives a referral, the agent is placed third in queue to receive a referral.

Alternatively, the ranking application may utilize a plurality of parameters to rank agents for selection of an agent for an input referral. In one embodiment, the plurality of parameters includes number of referrals given by the agent, amount of commissions earned from the previous referrals by the agent, acceptance percentage of referrals and the satisfaction of the persons using the selected agent. Those skilled in the art will recognize that other parameters, or more or less parameters, may be used to rank the pool of agents. In one embodiment, when an agent registers, the agent is ranked within a geographic location for which the agent is licensed to provide services. For example, if the agent is licensed in Nevada, the agent is ranked amongst the other registered Nevada agents. In one embodiment, the agent is ranked at the bottom of the pool of registered agents based on being the newest registered agent. Alternatively, the agent may be randomly ranked. As detailed below, the agent may immediately move up the rankings by providing referrals to agents in other jurisdictions via the website or App.

In one embodiment, the system 100 uses a weighted structure to rank the registered agents in each defined geographic area (e.g., by county or city depending on the size). By way of example, an agent may be ranked by (i) the number of referrals given by the agent, (ii) amount of commissions earned from the previous referrals by the agent, (iii) acceptance percentage of referrals and (iv) the satisfaction of the persons using the selected agent. Table 1 below lists data for five agents in a subject city.

TABLE 1

| | | | | | % OF |
|---|---|---|---|---|---|
| | | | REFERRAL | | REFERRED |
| | # OF | AMOUNT OF | ACCEPTANCE | SATISFACTION | DEALS |
| AGENT | REFERRALS | COMMISSIONS | % | LEVEL | CLOSED |
| SMITH | 4 | $45,000 | 80 | 90 | 85 |
| JOHNSON | 3 | $37,500 | 100 | 85 | 90 |
| WHITE | 3 | $52,000 | 75 | 85 | 100 |
| JONES | 2 | $9,500 | 100 | 100 | 100 |
| WASHINGTON | 1 | $6,000 | 100 | 65 | 100 |

Using the data in Table 1, the system 100 generates a total score or value of each agent from which rankings can be determined. In one embodiment, the primary contributor (e.g., 50%-75% of total score or value) to the total score or value is the number of referrals and commissions generated from the same. In other words, the system 100 values quality referrals over any other parameter. Accordingly, the more a user refers clients and/or business, the more likely the user is to receive referrals. The referral acceptance percentage, satisfaction level and percentage of referred deals closed are afforded less weight given the subjective nature of each parameter. That is, an agent may have good reasons to not accept a referral, clients can provide poor satisfaction reviews based on unrealistic expectations or lack of understanding and deals may not close based on any number of reasons unrelated to the referred agent. In a simplest form, a ranking algorithm comprises a number of referrals made times a percentage multiple related to negative parameters, commission average below a threshold value, referral acceptance % below a threshold value, satisfaction level below a threshold level and % of referred deals closed below a threshold value. In one embodiment, the multiple is 0.9 (aka 90%) every time one of the parameters falls below the threshold value. Thus, if an agent has given out referrals but the associated commissions are below a threshold value and the agent's satisfaction level is below a threshold value, the number of referrals (3) is multiplied by 0.9 two times, one for each poor parameter. Accordingly, the agents total score or value is 3×0.9×0.9=2.43. Each registered agent's score may then be used by the system 100 to determine where to send referrals. In one embodiment, the system 100 may use a random generator to send referrals such that agents having higher point totals or better parameters have a better chance to receive referrals according to a weighted scale. Alternatively, agents with better total scores receive better deals (e.g., higher commissions). In another embodiment, all registered agents receive referrals in order from highest total score to lowest total score at which time the system 100 resets with new registered agents being placed at the top and existing agents being ranked thereunder based on the agent's total score. In one embodiment, all agents referring clients or business receive at least the same number of referrals if available.

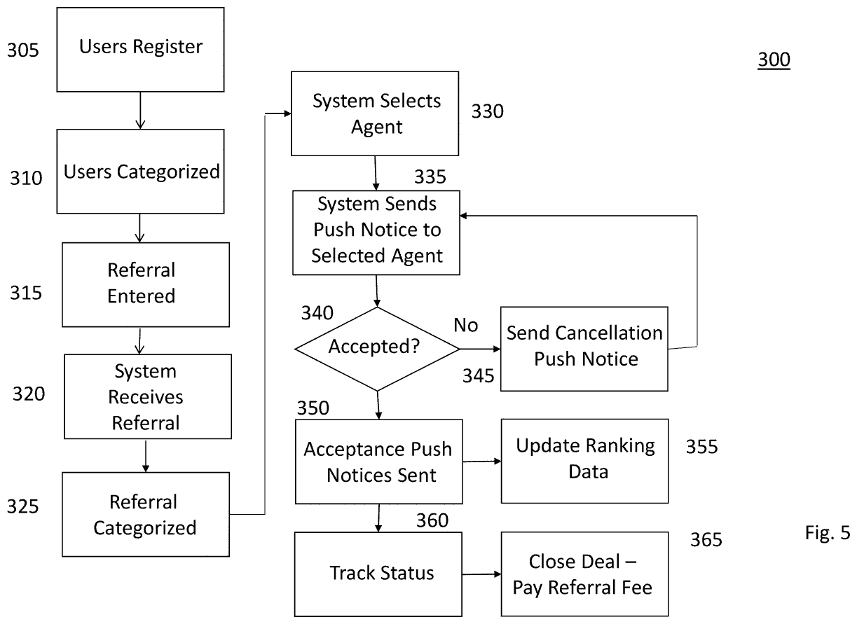

FIG. 5 shows a flow chart 300 detailing a method of operating the referral system 100 of the embodiments of the present invention. At 305, users register to be part of the referral network. Registration may include verification of each user's credentials, qualifications and reputation via third party providers. At 310, users are categorized based on geographic location. Users may be categorized in multiple jurisdictions if licensed in multiple jurisdictions. Once registered, users are able to enter referrals and receive referrals. At 315, a user enters a referral via the dedicated website or App. At 320, the system 100 receives the entered referral. At 325, the referral is categorized by geography (e.g., zip code, city, county, etc.). At 330, the system 100 selects the highest-ranking agent to transmit the entered referral or randomly selects an agent based on a weighted scale or other quid pro quo scheme. At 335, the system 100 transmits, or causes to be transmitted, a push notification to the selected agent indicating the availability of a referral. While push notices are described, the system 100 may also use emails, SMS, IM or other messages to notify the selected agent of the availability referral. At 340, it is determined if the selected agent has accepted the referral within an allotted acceptance time period (e.g., 30 minutes). If not, the chart 300 loops back to 335 where the system 100 transmits the referral to a second-ranking agent and, at 345, sends a cancelation push notice to the first-ranking agent. If accepted, at 350, the system sends a push notice to the agent entering the referral indicating that the referral has been accepted. The push notice may include a chat feature or link to the same. The chat feature allows the agent entering the referral to communicate with the agent receiving and accepting the same. At 355, ranking data is updated associated with the agent entering the referral and accepting the referral. At 360, the system 100 communicates with an escrow company or similar entity involved with the referral. The link with the escrow company allows the system 100 to track the underlying transaction (e.g., property sale or purchase). At 360, at closing, the App operator/owner receives its payment for putting the referring party and referred party together.

An example is now set forth. Sue lists a home for the Smiths in Ann Arbor, Mich. for $600,000. The Smiths plan on moving to Scottsdale, Ariz. as soon as their home sells. Sue tells the Smiths she can locate them an agent in Scottsdale to assist with purchasing a home. The Smiths are elated to receive a referral in their new home location given they do not have any contacts in Scottsdale. Sue then utilizes the system 100 to locate an agent in Scottsdale to receive the referral. The system 100 then locates an agent and undertakes the process described above in relation to the flow chat 300. Sue makes her normal commission on the sale of the Ann Arbor property but also makes a referral fee (e.g., 25% of the working agent's commission). Thus, in this instance, if the working agent having received the referral earns a $21,000 commission, Sue will earn $5250. The operator of the referral system 100 receives a flat fee (e.g., $500). Based on the referral by Sue, she moves up the rankings to receive a referral in her geographic area (i.e., Ann Arbor) when available.

A second example is now set forth. John, who is an agent licensed in Nevada, is told by his friend who lives in Anaheim, Calif., that he attends to sell his house in Anaheim. However, John is not licensed in California. John advises his friend that he is able to refer an agent licensed in California and near Anaheim. John uses the system 100 to enter the referral and the system locates an agent and undertakes the process described above in relation to the flow chart 300. John's friend tells John that he intends to move to Sacramento, Calif. Again, John is able to use the system 100 to refer his friend to an agent in Sacramento. In this instance, John is able to earn two referral fees and move up the ranking ladder to receiving referrals.

In one embodiment, to further encourage use of the system 100, agents receiving referrals may be required to provide cash rebate (e.g., $500) to the client (e.g., home buyer or seller). The cash rebate may be based on the purchase or sales price of the property as well.

In one embodiment, affiliated home professionals, such as home inspectors, appraisers, mortgage brokers, home insurance agents, alarm installers, etc., may be added to the system 100 as additional referral targets. In one embodiment, such affiliated home professionals pay a monthly fee to join the system 100. Like real estate agents and brokers, the affiliated professionals may be vetted via an application process before being permitted to join the referral network. Third party websites like Home Advisor, Yelp and others may be used to collect practical information regarding the affiliated home professionals. This same type of extension of service providers is adaptable with other industries as well. For example, in an attorney referral system according to the embodiments of the present invention, legal experts, research jury selection consultants, third party intellectual property clearance firms, etc., may join an attorney referral network.

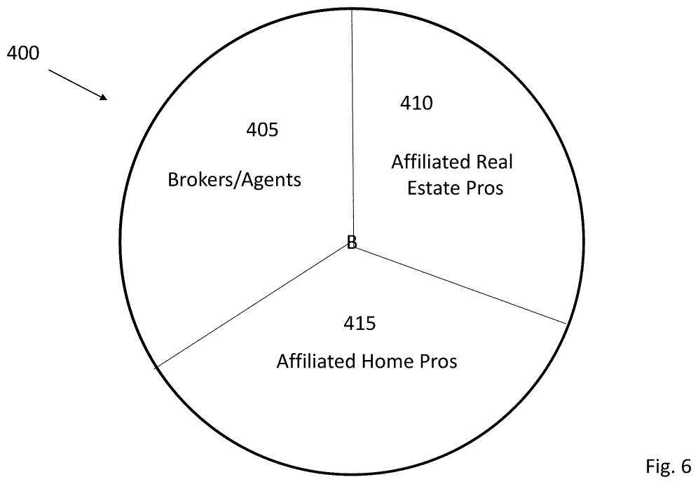

FIG. 6 shows a diagram depicting a referral network 400 according to the embodiments of the present invention. In a real estate embodiment, the referral network 400 comprises agents/brokers 405, affiliated real estate professionals 410 and affiliated home professionals 415.

While several ranking applications are disclosed herein, it is apparent that the service providers may be ranked according to many different parameters provided “referrals made” by the service provider increases the likelihood (whether systematically or randomly selected) that a service provider will be selected to receive a referral. In other words, the system and method detailed herein are intended to reward, through reciprocity, those service providers providing referrals to other service providers.

Although the invention has been described in detail with reference to several embodiments, additional variations and modifications exist within the scope and spirit of the invention as described and defined in the following claims.

1. A system comprising:
a computer having memory and one or more processors, said one or more processors running executable instructions to:
(i) register a plurality of service providers in a database by receiving personal information input by service providers regarding each of said service providers and confidential data related to each of said service providers to permit each of said service providers to be registered to access a referral network maintained by said system;
(ii) categorize each of said plurality of registered service providers by geographic location such that registered service providers licensed in a same defined geographic location are categorized together;
(iii) accept a referral request for a particular service from one of said plurality of registered service providers using a user interface associated with said system, said referral request including a geographic location where said particular service is to be provided;
(iv) automatically identify a registered service provider to receive said referral request, said identified registered service provider licensed in said geographic location where said particular service is to be provided, said registered service provider identified to receive said referral request selected from a ranking of registered service providers based on one or more of: a number of referral requests made and a value of said number of referral requests made by said referring service providers;
(v) transmit a digital referral request message to an electronic device associated with said identified registered service provider along with an active acceptance icon of said digital referral request message, said active acceptance icon automatically deactivated after a pre-established period of time;
(vi) cancel said digital referral request message after passage of said pre-established period of time without said of active acceptance icon being utilized and transmit said digital referral request message to a next automatically identified registered service provider licensed in said geographic location where said particular service is to be provided and from said ranking of registered service providers and continue to do so until one of said identified registered service providers from said ranking of registered service providers accepts said digital referral request message via said active acceptance icon within said pre-established period of time;
(vii) store in said memory at least a number of accepted referral requests made and a value of said number of referral requests made by each of said referring service providers and ranking each of said referring service providers based thereon; and
(viii) after acceptance of said referral request reward said referring service provider by increasing said ranking of said referring service provider thereby increasing the opportunity that said referring service provider will be selected to receive a future referral request message.

2. The system of claim 1 wherein said one or more processors are further running executable instructions to: upon acceptance by one of said identified registered services providers, transmit a digital acceptance message regarding said digital referral request message to said referring service provider.

3. The system of claim 1 wherein said one or more processors are further running executable instructions to: maintain a chat function between said referring service provider and said one of said identified registered service providers accepting said digital referral request message.

4. The system of claim 1 wherein said one or more processors are further running executable instructions to: automatically identify a registered service provider from a list of ranked registered service providers.

5. The system of claim 1 wherein said one or more processors are further running executable instructions to: randomly identify, using a weighted scale, a registered service provider to receive a referral request message.

6. (canceled)

7. The system of claim 1 wherein said one or more processors are further running executable instructions to: automatically deduct a fee, at closing of any transaction resulting from an accepted referral request message, for an operator or owner of the system.

8. A system comprising:
a computer having one or more processors, said one or more processors running executable instructions to:
a computer having one or more processors, said one or more processors running executable instructions to:
(i) register a plurality of service providers in a database by receiving personal information input by service providers regarding each of said service providers and confidential data related to each of said service providers to permit each of said service providers to be registered to access a referral network maintained by said system;
(ii) categorize each of said plurality of registered service providers by geographic location such that registered service providers licensed in a same defined geographic location are categorized together;
(iii) within each defined geographic location, rank registered service providers by at least one or more of the following: a number of referral requests made and a value of said number of referral requests made by each of said registered service providers;
(iv) based on said rank within said geographic location, automatically identify a registered service provider to receive said referral request, said identified registered service provider licensed in said geographic location where said particular service is to be provided, said registered service provider identified to receive said referral request selected from a ranking of registered service providers based on one or more of: a number of referral requests made and a value of said number of referral requests made by said referring service providers;
(v) transmit a digital referral request message to an electronic device associated with said identified registered service provider along with of an active acceptance icon of said digital referral request message, said active acceptance icon automatically deactivated after a pre-established period of time;
(vi) cancel said digital referral request message after passage of said pre-established period of time without said active acceptance icon being utilized and transmit said digital referral request message to a next automatically identified registered service provider licensed in said geographic location where said particular service is to be provided and from said ranking of registered service providers and continue to do so until one of said identified registered service providers from said ranking of registered service providers accepts said digital referral request message via said active acceptance icon within said pre-established period of time;
(vii) store in said memory at least a number of accepted referral requests made and a value of said number of referral requests made by each of said referring service providers and ranking each of said referring service providers based thereon; and
(viii) after acceptance of said referral request, reward said referring service provider by increasing said rank of said referring service provider thereby increasing the likelihood that said referring service provider will receive a future referral request message.

9. The system of claim 1 wherein said one or more processors are further running executable instructions to: upon acceptance by one of said identified registered services providers, transmit a digital acceptance message regarding said digital referral request message to said referring service provider.

10. The system of claim 1 wherein said one or more processors are further running executable instructions to: maintain a chat function between said referring service provider and said one of said identified registered service providers accepting said digital referral request message.

11. The system of claim 1 wherein said one or more processors are further running executable instructions to: automatically deduct a fee, at closing of any transaction resulting from an accepted referral request message, for an operator or owner of the system.

12-18. (canceled)
